(19) United States
(12) Patent Application Publication
(10) Pub. No.: US 2009/0228555 A1
(43) Pub. Date: Sep. 10, 2009

(54) Automated contact list determination based on collaboration history

(75) Inventors: Paul A. Joviak, Hudson, NH (US); Ram Krishnamurthy, Westford, MA (US); Julia Pogrebnyak, Somerville, MA (US); Anuphinh P. Wanderski, Durham, NC (US)

Correspondence Address: Cuenot, Forsythe & Kim, LLC, 20283 State Road 7, Ste. 300, Boca Raton, FL, 33498, US

(73) Assignee: INTERNATIONAL BUSINESS MACHINES CORPORATION, Armonk, NY (US)

(21) Appl. No.: 12/044,936

(22) Filed: Mar. 8, 2008

(51) Int. Cl. G06F 15/16

(52) U.S. Cl. 709/205

(57) ABSTRACT

A computer-implemented method of automated contact list determination can include detecting a collaborative event in real time and, responsive to detecting the collaborative event, identifying an owner of an electronic message and at least one contact specified by the electronic message, wherein the electronic message is associated with the collaborative event. The contact can be added to a collaborative contact list for the owner. The method can include determining a collaborative ranking for each contact in the collaborative contact list according to a collaborative history between the owner and that contact, selecting a plurality of contacts from the collaborative contact list according to collaborative ranking, and including each of the plurality of contacts within a dynamic address book of the owner.

### FIELD OF THE INVENTION

The embodiments of the present invention relate to automatically generating a contact list according to collaboration history.

### BACKGROUND OF THE INVENTION

Computer-based messaging systems have become pervasive. Chat, or so called instant messaging (IM), systems, electronic mail systems, and the like facilitate collaboration among users. Modern messaging systems allow more people to communicate, more effectively, and with less effort. In consequence, the number of people with whom one may communicate throughout the day, week, or month continues to grow.

The vehicle for managing these communications, or collaborations, typically is some sort of contact management function within the particular messaging client being used. Each user typically adds, removes, and/or updates contacts within an electronic address book that is integrated into the user's communication client. Often this is a manual process. As the number of contacts in the address book increases, management of the address book becomes more burdensome. Moreover, the ability to quickly locate a desired contact decreases as the number of contacts within the address book increases.

### SUMMARY OF THE INVENTION

The embodiments disclosed herein relate to automatically generating a contact list according to collaboration history. One embodiment of the present invention can include a computer-implemented method of automated contact list determination. The method can include detecting a collaborative event in real time and identifying an owner of an electronic message and at least one contact specified by the electronic message, wherein the electronic message is associated with the collaborative event. The contact can be added to a collaborative contact list for the owner. The method can include determining a collaborative ranking for each contact in the collaborative contact list according to a collaborative history between the owner and that contact, selecting a plurality of contacts from the collaborative contact list according to collaborative ranking, and including each of the plurality of contacts within a dynamic address book of the owner.

Another embodiment of the present invention can include a computer-implemented method of suggesting contacts for an electronic message. The method can include, responsive to detecting an input specifying a character within a communication address field of an electronic message, selecting each contact from a contact list that corresponds to the specified character, wherein each selected contact collectively comprises a set of query contacts, sorting the set of query contacts according to collaborative ranking as determined according to an owner of the electronic message, and presenting at least a portion of the query contacts ordered according to collaborative ranking.

Another embodiment of the present invention can include a computer-implemented method of automated contact list determination. The method can include identifying a contact that is a subject of a query in real time. Responsive to identifying the contact, the contact can be added to a collaborative contact list for an initiator of the query; and, a collaborative ranking for each contact in the collaborative contact list can be determined according to a collaboration history between the owner and that contact. The collaboration history can include queries. The method also can include selecting a plurality of contacts from the collaborative contact list according to collaborative ranking and including each of the plurality of contacts within a dynamic address book of the owner.

Yet another embodiment of the present invention can include a computer program product including a computer-usable medium having computer-usable program code that, when executed, causes a machine to perform the various steps and/or functions described herein.

### BRIEF DESCRIPTION OF THE SEVERAL VIEWS OF THE DRAWINGS

FIG. 1 is a first block diagram illustrating a system for automatically determining a contact list in accordance with one embodiment of the present invention.

FIG. 2 is a second block diagram illustrating a technique for presenting contacts in accordance with another embodiment of the present invention.

FIG. 3 is a first flow chart illustrating a method of automatically generating a contact list in accordance with another embodiment of the present invention.

FIG. 4 is a second flow chart illustrating a method of presenting contacts in accordance with another embodiment of the present invention.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment, including firmware, resident software, micro-code, etc., or an embodiment combining software and hardware aspects that may all generally be referred to herein as a “circuit,” “module,” or “system.”

Furthermore, the invention may take the form of a computer program product accessible from a computer-usable or computer-readable medium providing program code for use by, or in connection with, a computer or any instruction execution system. For the purposes of this description, a computer-usable or computer-readable medium can be any apparatus that can contain, store, communicate, propagate, or transport the program for use by, or in connection with, the instruction execution system, apparatus, or device.

Any suitable computer-usable or computer-readable medium may be utilized. For example, the medium can include, but is not limited to, an electronic, magnetic, optical, electromagnetic, infrared, or semiconductor system (or apparatus or device), or a propagation medium. A non-exhaustive list of computer-readable media can include an electrical connection having one or more wires, an optical fiber, magnetic storage devices such as magnetic tape, a removable computer diskette, a portable computer diskette, a hard disk, a rigid magnetic disk, a magneto-optical disk, an optical storage medium, such as an optical disk including a compact disk-read only memory (CD-ROM), a compact disk-read/write (CD-R/W), or a DVD, or a semiconductor or solid state memory including, but not limited to, a random access memory (RAM), a read-only memory (ROM), or an erasable programmable read-only memory (EPROM or Flash memory).

A computer-usable or computer-readable medium further can include a transmission media such as those supporting the Internet or an intranet. Further, the computer-usable medium may include a propagated data signal with the computer-usable program code embodied therewith, either in baseband or as part of a carrier wave. The computer-usable program code may be transmitted using any appropriate medium, including but not limited to the Internet, wireline, optical fiber, cable, RF, etc.

In another aspect, the computer-usable or computer-readable medium can be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices such as, for example, keyboards, displays, pointing devices, etc., can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the currently available types of network adapters.

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The embodiments of the present invention relate to generating a contact list in an automated manner. The contact list can be generated in real time responsive to detecting various types of collaborative activities between users. The contact list further can be generated based upon a collaborative history of a selected user, referred to as the “owner,” with various other users. Contacts ranked highly according to a collaborative ranking used to evaluate and/or quantify the collaborative history can be dynamically added to an address book for the owner. When creating or sending an electronic message, the contacts can be recalled and presented or otherwise made available to the owner in an order that is determined according to the collaborative history, or collaborative rank, of each presented contact.

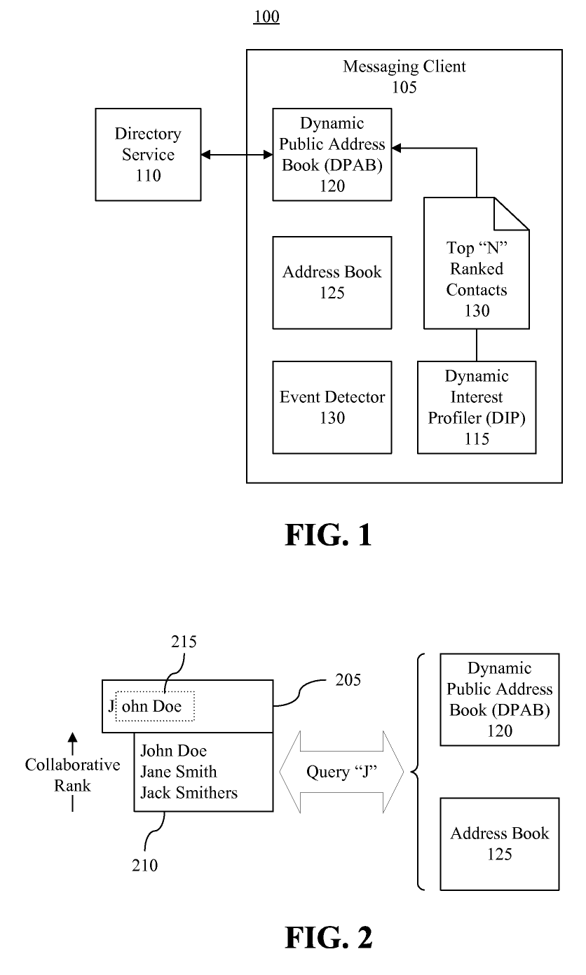

FIG. 1 is a first block diagram illustrating a system 100 for automatically determining a contact list in accordance with one embodiment of the present invention. The system 100 can automatically and dynamically generate a set of contacts and populate those contacts into an address book based upon a collaboration history of a user. The system 100 can perform these functions in real time responsive to detecting various types of collaborative activities.

The system 100 can include a messaging client 105 and a directory service 110. It should be appreciated that the messaging client 105 and the directory service 110 can be communicatively linked via a communication network (not shown). The communication network can be implemented as, or include, without limitation, a WAN, a LAN, the Public Switched Telephone Network (PSTN), the Web, the Internet, and one or more intranets. The communication network further can be implemented as or include one or more wireless networks, whether short or long range, including mobile communication networks.

The messaging client 105 can be implemented as an application executing within a suitable data processing system (not shown), e.g., a computer system, portable computer, mobile computer, or the like. As shown, the messaging client 105 can include a dynamic interest profiler (DIP) 115, a dynamic public address book (DPAB) 120, an address book 125, and an event detector 130. The messaging client 105 can be implemented as any of a variety of different messaging clients. For example, the messaging client 105 can be a chat client, an instant messaging client, an electronic mail client, a text messaging client, etc.

Chat, instant messaging, text messaging, and other forms of real time or near real time communications, whether text based or involving audio and/or video, will be referred to within this specification as “chat.” As used herein, “real time” can refer to a computer-based operating mode where data is captured and made available as it is happening. A real time process facilitates immediate interaction with the data as it is created. For example, in the context of an interactive or collaborative communication session, e.g., chat, data can be captured, transmitted, and rendered by a receiving client with sufficient speed and low latency as to facilitate a conversation or other ongoing interaction or collaboration between users without substantial delay between transactions.

The event detector 130 can detect various types of collaborative events. A collaborative event can refer to, or identify, an action, transaction, process, or the like, pertaining to a particular type of electronic message. An electronic message (message) can refer to a chat message, an electronic mail message, or any other type of electronic message. For example, a collaborative event can include the sending of a message, the receipt of a message, the opening of a message, or the like. By defining a collaborative event as the opening of a message, as opposed to receiving the message, the set of messages that are processed can be reduced to a more relevant set, effectively filtering out messages that are received but not opened. The message identified by, and associated with, the collaborative event is the message that is either sent or received, e.g., the message that is acted upon or processed.

The event detector 130 can detect collaborative events in real time such as the sending of a message, the receipt of a message, the opening of a message, or the like. In one embodiment, the event detector 130 can be a component that monitors activities of the inbox and/or the outbox of the messaging client 105. Responsive to detecting a collaborative event, the event detector 130 can immediately notify the DIP 115 of the occurrence of the collaborative event, e.g., in real time. As noted, since the collaborative event is associated with a particular message, the DIP 115 can identify the message associated with, or specified by, the notification received from the event detector 130.

Responsive to receiving notification from the event detector 130, the DIP 115 can automatically process the message associated with the collaborative event. More particularly, the DIP 115 can process the message and extract collaborative information from the message. The collaborative information can specify data including, but not limited to, the sender and recipient(s) of the message, a timestamp indicating the date and/or time the message was sent, received, and/or opened, and the type of the message, e.g., chat or electronic mail. A recipient of a message can refer to any user specified within a communication address field of the message, whether the “to” field, the “carbon copy” field, or the “blind copy” field. From time to time within this specification, the term “owner” will be used to refer to the user associated with the subject messaging client, e.g., messaging client 105. In that sense, the owner “owns” the messaging client 105. In the context of a sent message, the owner can be the sender of the electronic message. In the context of a received message, the owner will be a recipient of the electronic message, but not necessarily the individual specified in the “to” field.

The DIP 115 can maintain DIP data, referred to as a collaborative contact list. Responsive to being notified of the collaborative event and processing the message, the DIP 115 can update the collaborative contact list in real time with any collaborative information extracted from the message. The collaborative contact list can specify any contacts extracted from messages associated with detected collaborative events as described herein. The collaborative contact list can include any other information that is extracted from messages for each contact. In this regard, the collaborative contact list can specify a collaboration history for the owner, or for messaging client 105, as the case may be. The collaborative contact list can specify, for example, the number of times the owner has collaborated with a given user during a specified period of time, e.g., sent, received, or opened messages involving the user, a timestamp for each collaborative event, and the type of collaboration or message type. From the collaborative contact list, further parameters can be calculated by the DIP 115 and added such as frequency of collaborations between each user and the owner, recency of collaborations between each user and the owner, or the like.

It should be appreciated that the collaborative contact list can store collaboration history for a predetermined period of time, e.g., the last week, month, year, etc. Further, though referenced as a “list,” it should be appreciated that the collaborative contact list can be specified in any of a variety of different formats, e.g., table, database, or the like.

The DIP 115 can calculate a collaborative rank for each contact specified within the collaborative contact list. This process can be performed responsive to each update of the collaborative contact list, e.g., in real time. The collaborative rank can be a function of the various parameters noted herein that are stored and/or calculated for each contact in the collaborative contact list. The DIP 115 can automatically compute a collaborative rank for each contact in the collaborative contact list. Thus, responsive to being notified of a collaborative event in real time, the collaborative information can be extracted from the subject message and added to the collaborative contact list. The DIP 115 can then calculate and/or update the collaborative rankings.

The term “contact” is used within this specification to refer to users as well as contact records for users within various lists and data structures. The content of a contact may vary from one component of the system to another as will be described herein in greater detail. For example, a contact may refer to a contact record stored within the collaborative contact list that may include only a limited set of data such as a communication address and a rank for that communication address. In other cases, the contact can include additional information or be updated to include additional information as described herein. A communication address, as used herein, can refer to an electronic mail address, a chat address, or other identifier that can be used to identify a particular user and route an electronic message to that user within a computer-based communication network.

In another example, the collaborative contact list can include, for each contact, only a communication address, a collaborative ranking, and any other collaborative data extracted from messages or calculated from such extracted data. A contact may include a user name, if available from the extracted collaborative information. The contacts specified in the collaboration contact list, however, need not specify more complete information, e.g., home mailing addresses, corporate information, telephone numbers, etc. which are likely to be included within the directory service 110.

The DIP 115 can identify, select, and output the top “N” ranked contacts from the collaborative contact list as list 130 of top “N” ranked contacts. As used herein, “output” or “outputting” can mean, for example, storing data in memory, writing data to a file, writing data to a user display or other output device, playing audible notifications, sending or transmitting data to another system, exporting, or the like.

In this example, the value of “N” can be a predetermined integer value that does not exceed the total number of contacts specified in the collaborative contact list of the DIP 115. The value of “N” can be an adjustable value that can be set via a preference setting. For example, if the DIP 115 includes 3,000 contacts, the value of “N” can be established as some integer that does not exceed, but likely is less than 3,000. For instance, “N” can be set equal to 100, 500, 1,000, 2,000, etc. This allows the number of contacts within the DPAB 120 to be regulated or adjusted by changing the value of “N.” The list 130 of top “N” ranked contacts can be sorted or ordered according to the collaborative rank of each contact in the list 130.

In one embodiment, the data specified by the list 130 of top “N” ranked contacts can include only a communication address, e.g., an electronic mail address or a chat address, and the collaborative ranking corresponding to each communication address. In another embodiment, each contact also can include a user name or other identifier. Other collaborative information available in the collaborative contact list need not be provided as part of the list 130.

The DIP 115 can determine and output the list 130 of top “N” ranked contacts to the DPAB 120 in real time, for example, responsive to any notification received by the event detector 130 and/or after any updating of the collaborative contact list is performed. The DPAB 120 can receive the list 130 of top “N” ranked contacts and create a record for each contact specified on the list 130 of top “N” ranked contacts. As noted, the contacts specified in the list 130 of top “N” ranked contacts can include a limited amount of information. Accordingly, the DPAB 120 can query the directory service 110 to obtain additional information for each contact on the list 130 of top “N” ranked contacts.

For example, the directory service 110 can be an organizational directory or a corporate directory that stores a profile for each employee, mailing address, a telephone number, and/or other organizational data. The directory service 110 can be implemented as an application executing within a suitable data processing system, e.g., a host computing system or server. For one or more or each of the contacts loaded into the DPAB 120 of the owner, the DPAB 120 can query the directory service 110 to obtain additional information for such contacts.

The directory service 110 can output a query response specifying information for any contacts stored in the directory service 110 that match contacts specified by the query from the DPAB 120. The DPAB 120 can receive the query results and can update the appropriate contacts with the received information. In this regard, the DPAB 120 can be automatically populated and dynamically updated or synchronized with the directory service 110.

It should be appreciated that once the DPAB 120 is populated with an initial list of top “N” ranked contacts, further updates can be performed incrementally. That is, responsive to a further detected collaborative event, a new list of top “N” ranked contacts can be generated by the DIP 115 and received by the DPAB 120. In one embodiment, the DPAB 120 can purge contacts stored therein and begin the automatic population and update process anew based upon the newly received list of top “N” ranked contacts.

In another embodiment, the DPAB 120 can compare the new list of top “N” ranked contacts with the contacts already existing within the DPAB 120 and identify any differences. A contact record can be created for each contact specified in the new list of top “N” ranked contacts that does not exist in the DPAB 120. The DPAB 120 can query the directory service 110 to determine additional information for such contacts and update the corresponding contact records as described. Contacts that exist in the DPAB 120 that are not specified in the new list of top “N” ranked contacts can be purged from the DPAB 120. Such contacts likely have a collaborative rank that does not place the contact within the top “N” contacts.

In yet another embodiment, the DIP 115, after providing an initial list of top “N” ranked contacts, can output only changes to the list. That is, rather than outputting a complete list of top “N” ranked contacts responsive to each detected collaborative event, the DIP 115 can output instructions to the DPAB 120 indicating which contacts to add and which to delete. For each contact to be added, the ranking of that contact also can be provided.

In the embodiment pictured in FIG. 1, the DPAB 120 is shown independently of the address book 125. The address book 125 can be a conventional address book in which the owner can add or remove contacts, edit contacts, or the like. Though shown separately, it should be appreciated that the DPAB 120 can be implemented as a part of the address book 125, separately from address book 125 as shown, or even remotely located from the messaging client 105, e.g., within a different data processing system.

In any case, within the messaging client 105, the owner can be provided with a view that presents only those contacts within the DPAB 120. The owner, working through the messaging client 105, e.g., the DPAB 120 specific view, can manually add or remove contacts if so desired. Manually adding a contact to the DPAB 120 will cause that contact to be added to the collaborative contact list of the DIP 115. Manually deleting a contact from the DPAB 120 will cause that contact to be removed from the collaborative contact list of the DIP 115. In another embodiment, contacts can be automatically removed from the DPAB 120 when the contact is not the subject of any collaboration with the owner for more than a predetermined period of time, regardless of the collaborative ranking of the contact. In that case, the contact also can be removed from the collaborative contact list of the DIP 115.

In another aspect, the contact records, once established and updated within the DPAB 120 from the directory service 110, can be non-editable. That is, apart from adding or deleting such contacts, the owner may be prevented from editing the contact records. In one embodiment, the owner can be provided with a function that can copy a contact from the DPAB 120 to the address book 125 of the user, e.g., the owner. Once copied as a contact record into the address book 125, the contact may be edited by the owner.

FIG. 1 has been described largely in the context of a messaging client. It should be appreciated, however, that the embodiments disclosed herein are not intended to be limited to such a configuration. For example, another variety of system can be implemented that allows an owner to lookup or search for other users, e.g., employees, within an organization. The subjects of the query, whether specified in the query itself, e.g., unambiguously, or within accessed query results, can be considered to have collaborated with the owner. In this example, the owner is the initiator of the query. The collaborative event can be the issuance of the query. The message that is evaluated and associated with the collaborative event can be the query result.

In cases where more than one contact record is returned, indicating ambiguity as to the particular subject of the search, the opening of a particular contact record can indicate that the selected or accessed contact record is the message from which collaborative data can be extracted. The contacts determined in this manner can be added to the collaborative contact list as described. A collaborative ranking for such contacts can be determined from a collaboration history that can include queries, e.g., queries, query results, and/or accessed query results. In this example, the collaborative event can be the initiation of a query and the message from which collaborative data is extracted can be the result of the query or the accessed result(s) of the query. It should be appreciated that when the query specifies a contact unambiguously, the query can be the message from which collaborative data is extracted. That is, collaborative data can be extracted directly from a query that unambiguously specifies a subject or that returns a single query result.

FIG. 2 is a second block diagram illustrating a technique for presenting contacts in accordance with another embodiment of the present invention. More particularly, FIG. 2 illustrates a “type ahead” function that can be implemented within a messaging client, such as the messaging client described with reference to FIG. 1, or other application. A “type ahead” function refers to a search technique that queries a contact list and retrieves search results. The search or query results can continue to be filtered in real time as the user continues to provide further input. Such techniques can be used, for example, within auto-complete functions when inputting a communication address into a communication address field of a message.

In the example shown in FIG. 2, a user has typed the character “J” in a communication address field 205 of a message. In response to receiving that input, the messaging client can query contact lists for contacts that begin with the letter “J”. As used herein, the term “character” can mean any letter, number, or symbol, e.g., any letter, number, or symbol as may be used in specifying a communication address.

As illustrated, the query can be executed against, or performed across, not only address book 125, but also DPAB 120. Any duplicates can be filtered out or removed from the query results. The contacts that are retrieved in response to the query can be ordered according to collaborative rank of each respective query result. The query results, or the top “N” query results, can be presented, in this example, within a drop down list 210.

The query results, including contacts “John Doe,” “Jane Smith,” and “Jack Smithers” are ordered according to collaborative ranking, where John Doe has the highest collaborative rank and Jack Smithers has the lowest. As shown, responsive to inputting the character “J”, the three contacts are returned as query results and displayed as selectable options for auto-completing communication address field 205. In the example shown, the contact with the highest collaborative rank can be automatically suggested as part of an auto-complete feature. For example, the portion “ohn Doe” 215 can be displayed within communication address field 205 as a suggested contact to complete the communication address started by the user.

In one embodiment, the search and auto-complete function can work with communication addresses, user names, alternate names, and/or aliases for users. For example, responsive to receiving the input “J” within communication address field 205, communication addresses, user names, alternate names, and aliases can be searched for matches, e.g., those contacts having a communication address, user name, alternate name, or alias starting with “J”. An alternate name can refer to a name specified in a different language than the primary language utilized for the messaging client, e.g., a language other than English. The alternate name may also be specified in a different or alternate character set. The alias refers to a short cut for a name. For example, “John Doe” may be an alias for “John S. Doe”. The suggestions for contacts, whether as auto-complete, e.g., 215, or within drop down box 210, can be displayed with any alternate names or aliases listed in parenthesis or specified in some other visual manner.

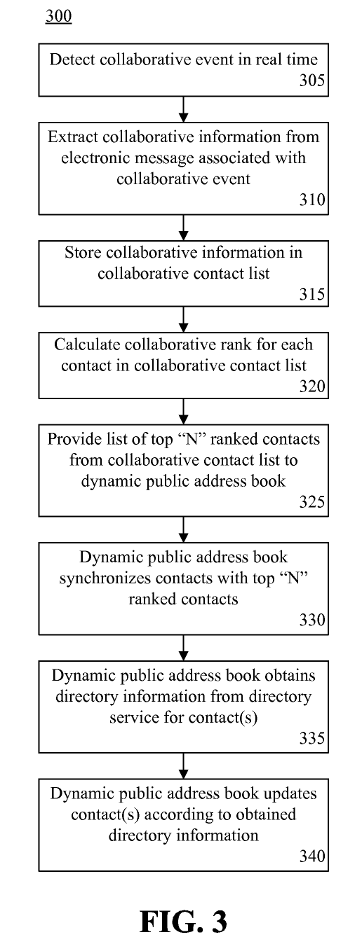

FIG. 3 is a first flow chart illustrating a method 300 of automatically generating a contact list in accordance with another embodiment of the present invention. The method 300 can be implemented in a system as described with reference to FIG. 1, e.g., a messaging client, or another application. The various steps described with reference to FIG. 3 can be performed responsive to the detection of a collaborative event in real time. That is, the detection of a collaborative event can drive the various processes steps described with reference to FIG. 3 such that the steps may be performed automatically and in real time. In this manner, the DPAB described with reference to FIG. 1 can be updated in real time or near real time responsive to each collaborative event. Such an update strategy avoids situations in which jobs for extracting data from messages are scheduled to run periodically, but do not execute when the messaging client is not executing. In accordance with the embodiments disclosed herein, the DPAB is continually updated, for example, any time a message is sent or received, and appears up to date to the end user.

Accordingly, the method 300 can begin in step 305 where the event detector detects a collaborative event. As noted, the collaborative event can be the sending of a message, the receipt of a message, the opening of a message, a query, or the like. The event detector can notify the DIP of the occurrence of the event and identify the subject message to the DIP. Accordingly, in step 310, the DIP can extract collaborative information from the electronic message associated with the detected collaborative event. In the case where a message is sent, each recipient of the message, the timestamp of the message, and the type of message can be determined. When a message is received or opened, the collaborative information can include each recipient and sender of the message, the timestamp of the message when received or opened, and the type of the message.

In step 315, the DIP can store the collaborative information extracted from the message within the collaborative contact list. It should be appreciated that the collaborative information extracted and stored within the collaborative contact list specifies a collaboration history that is specific to the owner of the messaging client.

In step 320, the DIP can calculate a collaborative rank for each contact within the collaborative contact list. The DIP can add the collaborative rank of each contact to the collaborative contact list. As noted, the collaborative rank can depend upon any information stored within the collaborative contact list, e.g., number of messages exchanged between owner and another user, recency of collaborative exchanges or messages, type of messages exchanged, frequency, or the like. For example, one or more or all of the various quantities or metrics described herein can be included within a function that, when calculated, produces or outputs a collaborative ranking for a contact. Within such a function, any quantity can be accorded greater or lesser weight or importance as deemed appropriate. As noted, the collaborative ranking of a user is a measure, metric, or assessment of the collaborative history between the owner and the subject user.

In step 325, the DIP can select the top “N” ranked contacts, according to collaborative ranking, from the collaborative contact list and output the top “N” ranked contacts in the form of a list. The DIP can provide the list of top “N” ranked contacts to the DPAB. That is, the DIP can push the list of the top “N” ranked contacts to the DPAB. As noted, where applicable, the DIP can output only changes, e.g., additions or deletions, to contacts stored in the DPAB in lieu of sending a complete list. Further, as noted, the list of the top “N” ranked contacts can include limited information. For example, in one embodiment, each contact in the list of top “N” ranked contacts can specify only a communication address, a collaborative rank, and optionally a user name or other identifier or alias.

In step 330, the DPAB, responsive to receiving the list from the DIP, can automatically synchronize the contacts stored therein with the top “N” ranked contacts received from the DIP. Thus, contacts can be added or deleted, e.g., records can be added or deleted, as may be required so that the contacts stored within the DPAB coincide or match the top “N” ranked list of contacts.

In step 335, the DPAB can automatically query the directory service to obtain more complete information for any newly added contacts. Thus, for any contact that is added to the DPAB in consequence of the most recent list of top “N” ranked contacts, the DPAB can query the directory service for that contact. Upon receiving a response from the directory service, in step 340, the DPAB can automatically update the appropriate contacts with the received directory information.

The contacts within the DPAB can be made available to the owner via any of a variety of different mechanisms. For example, the DPAB can be searched or used in an auto-complete function. The DPAB also can function cooperatively with a conventional address book.

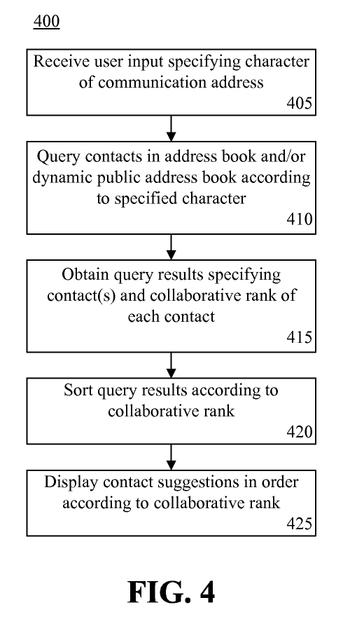

FIG. 4 is a second flow chart illustrating a method 400 of presenting contacts in accordance with another embodiment of the present invention. The method 400 can be implemented within a messaging client as described with reference to FIG. 1. Accordingly, the method 400 can begin in step 405, where a user input can be received that specifies a character of a communication address. The user input can be received within a communication address field of a message that is being created or within a search field of some other application.

In step 410, responsive to the received input, a query can be executed against the contacts within an address book and/or the contacts within the DPAB to locate those contacts beginning with the specified character. It should be appreciated that the search can be targeted to search only the address book of the user, only the DPAB, or both if so desired. As noted, the query can be executed or search against the communication address of each contact, an alias of each contact, an alternate name of each contact, or any combination thereof.

In step 415, the contacts determined from the query can be obtained along with the collaborative rank of each located contact. In one embodiment, for example, when contacts in the DPAB are searched, a collaborative rank for each matching contact can be returned. In other cases, e.g., where the address book is searched, the messaging client can query the DIP and obtain the collaborative rank for each contact located in the address book by the query. In that case, the collaborative rank as determined directly from the collaborative contact list in the DIP can be returned.

In step 420, the contacts identified by the query, e.g., the query results, can be sorted according to the collaborative rank of each contact. In step 425, the contacts, or some portion thereof, e.g., a smaller subset, can be displayed in an order determined according to collaborative ranking. As noted, in one embodiment, the contact having the highest collaborative rank can be suggested to the user via an auto-complete function. It should be appreciated that as the user continues to type further characters of the communication address, the list of contacts presented to the user can be further filtered or updated to specify only those contacts that correspond with the specified, or user input, characters.

The embodiments disclosed herein provide address book functionality that can automatically populate itself with important contacts and dynamically synchronize added contacts with data found in a directory service, e.g., a corporate directory. In addition, an intelligent type-ahead function is provided that displays important, frequently, and recently used contacts at the top of the displayed type-ahead list. Occasionally used or less relevant contacts can be presented at or near the bottom of the list or not at all.

The flowchart(s) and block diagram(s) in the figures illustrate the architecture, functionality, and operation of possible implementations of systems, methods, and computer program products according to various embodiments of the present invention. In this regard, each block in the flowchart(s) or block diagram(s) may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagram(s) and/or flowchart illustration(s), and combinations of blocks in the block diagram(s) and/or flowchart illustration(s), can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to the embodiments thereof, it will be apparent that modifications and variations are possible without departing from the scope of the invention defined in the appended claims.

What is claimed is:

1. A computer-implemented method of automated contact list determination comprising:
detecting a collaborative event in real time;
responsive to detecting the collaborative event,
identifying an owner of an electronic message and at least one contact specified by the electronic message, wherein the electronic message is associated with the collaborative event;
adding the contact to a collaborative contact list for the owner;
determining a collaborative ranking for each contact in the collaborative contact list according to a collaborative history between the owner and that contact;
selecting a plurality of contacts from the collaborative contact list according to collaborative ranking; and
including each of the plurality of contacts within a dynamic address book of the owner.

2. The computer-implemented method of claim 1, further comprising:
obtaining directory information, from a directory service, for at least one contact of the plurality of contacts included in the dynamic address book; and
updating the at least one contact according to the directory information.

3. The computer-implemented method of claim 1, wherein the collaborative event is a sending of an electronic message and the owner is the sender, wherein identifying an owner and at least one contact specified by the electronic message comprises identifying each recipient of the electronic message.

4. The computer-implemented method of claim 1, wherein the collaborative event is an opening of an electronic message and the owner is the recipient, wherein identifying an owner and at least one contact specified by the electronic message comprises identifying each non-owner recipient and sender of the electronic message.

5. The computer-implemented method of claim 1, wherein the plurality of contacts is comprised of the top “N” contacts, wherein “N” is a predetermined integer, the computer-implemented method further comprising automatically removing a contact from the dynamic address book of the owner when the collaborative ranking of the contact exceeds a value of “N.”

6. The computer-implemented method of claim 1, further comprising:
responsive to detecting an input specifying a character within a communication address field of an electronic message,
selecting each contact that corresponds to the specified character, wherein each selected contact collectively comprises a set of query contacts;
sorting the set of query contacts according to collaborative ranking as determined according to the owner of the electronic message; and
presenting at least a portion of the query contacts ordered according to collaborative ranking.

7. The computer-implemented method of claim 6, further comprising auto-completing the detected input using the contact having a highest collaborative ranking from the list of contacts.

8. The computer-implemented method of claim 1, wherein adding comprises pushing the contact to the collaborative contact list for the owner.

9. The computer-implemented method of claim 1, wherein each step is performed in real time and automatically responsive to detecting the collaborative event.

10. The computer-implemented method of claim 1, further comprising automatically removing a contact from the dynamic address book of the owner, irrespective of the collaborative ranking of the contact, after a predetermined amount of time where no collaboration between the contact and the owner is detected.

11. A computer-implemented method of suggesting contacts for an electronic message comprising:
responsive to detecting an input specifying a character within a communication address field of an electronic message,
selecting each contact from a contact list that corresponds to the specified character, wherein each selected contact collectively comprises a set of query contacts;
sorting the set of query contacts according to collaborative ranking as determined according to an owner of the electronic message; and
presenting at least a portion of the query contacts ordered according to collaborative ranking.

12. The computer-implemented method of claim 11, further comprising auto-completing the detected input using the contact having a highest collaborative ranking from the list of users.

13. The computer-implemented method of claim 11, further comprising determining a collaborative ranking for each contact according to a collaboration history between that contact and the owner.

14. A computer-implemented method of automated contact list determination operable responsive to a query, the computer-implemented method comprising:
identifying a contact that is a subject of a query in real time;
responsive to identifying the contact,
adding the contact to a collaborative contact list for an initiator of the query;
determining a collaborative ranking for each contact in the collaborative contact list according to a collaboration history between the owner and that contact, wherein the collaboration history comprises queries;
selecting a plurality of contacts from the collaborative contact list according to collaborative ranking; and
including each of the plurality of contacts within a dynamic address book of the owner.

15. A computer program product comprising:
a computer-usable medium comprising computer-usable program code that automatically determines a contact list and which is operable responsive to detecting a collaborative event, the computer-usable medium comprising:
computer-usable program code that detects a collaborative event in real time;
computer-usable program code that, responsive to the detected collaborative event,
identifies an owner of an electronic message and at least one contact specified by the electronic message, wherein the electronic message is associated with the collaborative event;
adds the contact to a collaborative contact list for the owner;
determines a collaborative ranking for each contact in the collaborative contact list according to a collaborative history between the owner and that contact;
selects a plurality of contacts from the collaborative contact list according to collaborative ranking; and
includes each of the plurality of contacts within a dynamic address book of the owner.

16. The computer program product of claim 15, wherein the computer-usable medium further comprises:
computer-usable program code that obtains directory information, from a directory service, for at least one contact of the plurality of contacts included in the dynamic address book; and
computer-usable program code updates the at least one contact according to the directory information.

17. The computer program product of claim 15, wherein the computer-usable medium further comprises:
computer-usable program code that, responsive to detecting an input specifying a character within a communication address field of an electronic message,
selects each contact that corresponds to the specified character, wherein each selected contact collectively comprises a set of query contacts;
sorts the set of query contacts according to collaborative ranking as determined according to the owner of the electronic message; and
presents at least a portion of the query contacts ordered according to collaborative ranking.

18. The computer program product of claim 17, wherein the computer-usable medium further comprises computer-usable program code that auto-completes the detected input using the contact having a highest collaborative ranking from the list of contacts.

19. The computer-program product of claim 15, wherein each portion of computer-usable program code operates in real time and automatically responsive to detecting the collaborative event.

20. The computer-program product of claim 15, wherein the computer-usable medium further comprises computer-usable program code that automatically removes a contact from the dynamic address book of the owner, irrespective of the collaborative ranking of the contact, after a predetermined amount of time where no collaboration between the contact and the owner is detected.
